(19) United States
(12) Patent Application Publication
(10) Pub. No.: US 2014/0012907 A1
(43) Pub. Date: Jan. 9, 2014

(54) SYSTEM, METHOD AND COMPUTER-READABLE MEDIUM FOR REMOTELY RE-AMPING A DIGITIZED SOUND TRACK

(71) Applicants: Paul Joseph Cavanaugh, Oakville (CA); John David Erickson, Oakville (CA); Steven Robert Kruspe, Oakville (CA); Gavin Wood Freitag, Oakville (CA)

(72) Inventors: Paul Joseph Cavanaugh, Oakville (CA); John David Erickson, Oakville (CA); Steven Robert Kruspe, Oakville (CA); Gavin Wood Freitag, Oakville (CA)

(73) Assignee: TRACKSTER INC., Oakville (CA)

(21) Appl. No.: 13/543,710

(22) Filed: Jul. 6, 2012

(51) Int. Cl. G06F 15/16; G06F 3/01

(52) U.S. Cl. 709/204; 715/738; 715/716

(57) ABSTRACT

A re-amping management and file distribution (RMFD) system remotely re-amps a digitized sound track recorded by a user on a user computing device having a data communication port for communicating the digitized sound track to the RMFD server. The system receives the digitized sound track, presents re-amping options to the user, receives at least one re-amping selection command from the user computing device, and transmits the digitized sound track to a studio server for re-amping of the digitized sound track.

### CROSS-REFERENCE TO RELATED APPLICATIONS

This is the first application filed for the present technology.

### TECHNICAL FIELD

The present technology relates generally to sound recording technologies for the music industry and, in particular, to techniques for re-amping a guitar track.

### BACKGROUND

Electric guitars may be connected to computers to record a digital sound track or sound file. However, the sound quality is not nearly as good as in a real sound studio equipped with quality amplifiers (“amps”). Traditional bricks-and-mortar recording studios are increasingly vacant due to the rise of computer-based recording techniques. However, for those with a desire to produce high-quality sound, it may be inconvenient and time-consuming to travel to the sound studio, especially where the musician is geographically far from a studio.

Accordingly, there is a need in the industry for a technology that addresses these issues.

### SUMMARY

The present invention provides a system, computer-readable medium and method for re-amping a sound track. Embodiments of the present invention enable a musician (user) to record a digitized sound track locally by connecting an electric guitar or other such instrument to a computer or other computing device. The digitized sound track is transmitted or uploaded by the user to a re-amping management and file distribution (RMFD) server, e.g. via a web connection. The RMFD server presents various re-amping options to the user via a web interface. The options include various amplifiers that are available and various sound effects that may be applied. Based on the selections made by the user, the server identifies one of a plurality of studios that have the selected amplifier and transmits the sound track to a studio server along with any applicable sound effect parameters. The server studio converts the sound track into an analog drive signal that plays the sound track through the selected amplifier in the recording studio. The reamped sound track is thus played acoustically in the sound studio using the sound effect parameters to set or configure the selected amplifier. A microphone captures the reamped sound to create a reamped sound track. The reamped sound track is then transmitted back to the user, either directly to the user computer or indirectly via the RMFD server.

Accordingly, one aspect of the present technology is a computer-implemented method computer-implemented performed by a re-amping management and file distribution (RMFD) server for remotely re-amping a digitized sound track. The method entails receiving the digitized sound track recorded by a user on a user computing device having a data communication port for communicating the digitized sound track to the RMFD server, presenting by the RMFD server a plurality of re-amping options to the user, receiving by the RMFD server at least one re-amping selection command from the user computing device to select at least one option, and transmitting the digitized sound track to a studio server for re-amping of the digitized sound track.

Another aspect of the present technology is a computer-readable medium comprising instructions in code which when loaded into a memory and executed by a processor of a web server cause the server to receive the digitized sound track recorded by a user on a user computing device having a data communication port for communicating the digitized sound track to the RMFD server, present by the RMFD server a plurality of re-amping options to the user, receive by the RMFD server at least one re-amping selection command from the user computing device to select at least one option, and transmit the digitized sound track to a studio server for re-amping of the digitized sound track.

Another aspect of the present technology is a re-amping management and file distribution (RMFD) system comprising a memory for storing application data including amplifier data, and a data communication port for receiving a digitized sound track recorded by a user on a user computing device. The system further includes a processor operatively coupled to the memory for presenting a plurality of re-amping options to the user, receiving at least one re-amping selection command from the user computing device to select at least one option, and transmitting the digitized sound track to a studio server for re-amping of the digitized sound track.

The details and particulars of these aspects of the technology will now be described below, by way of example, with reference to the drawings.

### BRIEF DESCRIPTION OF THE DRAWINGS

Further features and advantages of the present technology will become apparent from the following detailed description, taken in combination with the appended drawings, in which:

FIG. 1 is a schematic depiction of a system for remotely re-amping a digitized sound track in accordance with an embodiment of the present invention;

FIG. 2 is a flowchart depicting steps of a method of remotely re-amping a digitized sound track in accordance with an embodiment of the present invention;

FIG. 3 is a message flow diagram showing how a user computer communicates with a re-amping management and file distribution server which in turn communicates with one of a plurality of studio servers;

FIG. 4 depicts an example of a web-based user interface for enabling a user to remotely re-amp a digitized sound track; and

FIG. 5 depicts an example of another web-based user interface for enabling the user to remotely re-amp the digitized sound track.

It will be noted that throughout the appended drawings, like features are identified by like reference numerals.

### DETAILED DESCRIPTION

By way of overview, the present invention provides a system, computer-readable medium and method for re-amping a digitized sound track recorded by connecting an electric guitar or other such instrument to a user's computer or other computing device. The digitized sound track is uploaded to a re-amping management and file distribution (RMFD) system, e.g. a web server accessible by the user using an internet connection and a web browser. The RMFD system enables the user to select an amplifier and to specify sound effects. The RMFD then determines a studio having the amplifier and transmits the digitized sound track, the user's amplifier selection and any applicable sound effects to the studio server. The digitized sound track is re-amped and then sent back as a re-amped sound track to the user.

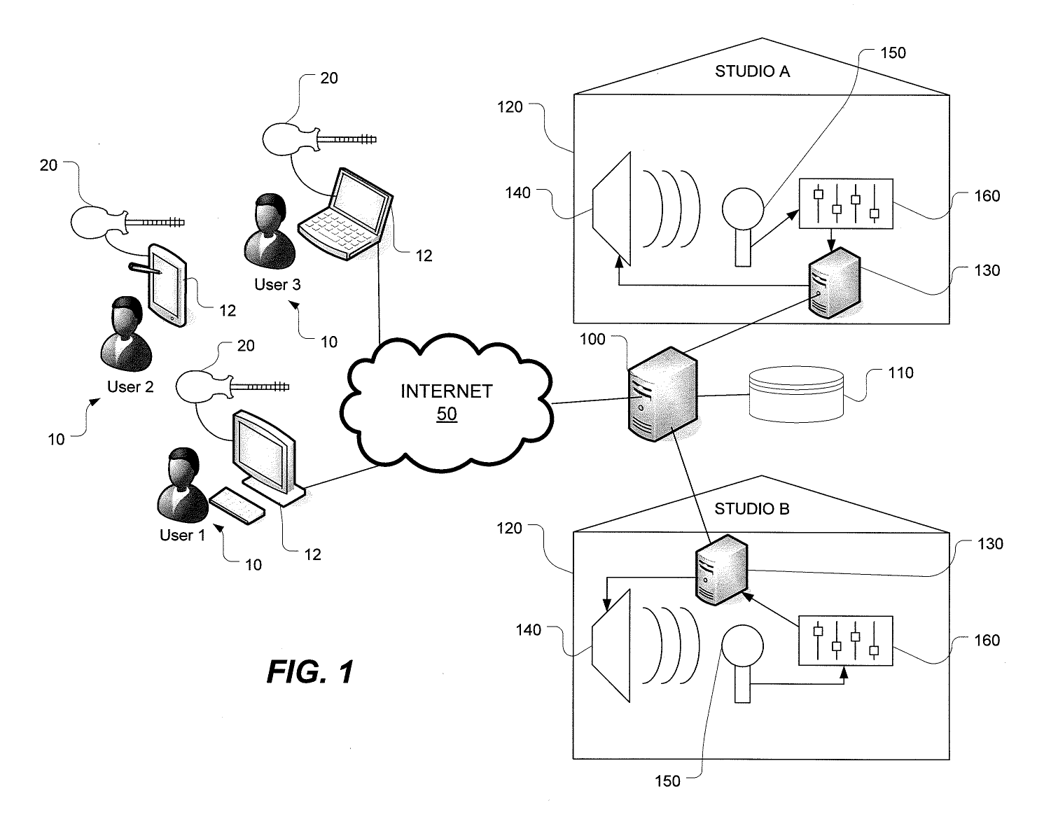

FIG. 1 is a depiction of a system for re-amping a guitar track or other digitized sound track of a musical instrument in accordance with one embodiment of the present invention. The system, as shown in FIG. 1, enables a user 10 to record a guitar track on a computer or other user computing device 12. The computing device 12 may be a desktop computer, laptop or mobile device. Other computing devices may include notebooks, palmtops, tablets, personal digitals assistants, web-enabled game consoles, or other such devices, apparatuses, equipment or systems. As noted above, the technologies disclosed herein may be employed on either wireless or wired devices. The digitized guitar track may be recorded in any suitable digital format, e.g. WAV, MP3, etc.

The computing device 12 includes a microprocessor (or simply “processor”) and a memory for executing one or more applications. The memory may include flash memory and/or random access memory (RAM). Other types or forms of memory may be used. The computing device 12 includes a user interface for interacting with the device and its applications and, in this instance, for receiving user input to interact with the web-based re-amp application as will be explained below. The user interface may include one or more input/output devices, such as a display screen, e.g. an LCD or LED screen or touch-sensitive display screen, and a keyboard or keypad 155. The user interface may also include a mouse, optical jog pad and/or a thumbwheel, trackball, track pad or any other input device.

The computing device 12 includes a data communication unit having a data communication port for connecting to the Internet 50 or other data network. For wired connections, the data communications unit of the computing device 100 may be a DSL or coax cable modem or equivalent capable of transferring data over the Internet using TCP/IP, HTTP or other such protocols. For wireless connections, this data communication port includes a radiofrequency (RF) transceiver for wirelessly communicating with one or more base stations over a cellular wireless network using cellular communication protocols and standards for both voice calls and packet data transfer such as GSM, CDMA, GPRS, EDGE, UMTS, LTE, etc. Where the computing device 100 is a wireless communications device, the device may include a Subscriber Identity Module (SIM) card 112 for GSM-type devices or a Re-Usable Identification Module (RUIM) card for CDMA-type devices.

To record the sound track, the user connects an electric guitar 20 or other such musical instrument to the computing device using a suitable data-transfer cable having a connecting means or connector adapted to connect to one of the data ports of the computing device. For example, the connector may be USB, FireWire (IEEE 1394), HDMI, etc.

The computing device receives the analog output signal from the electric guitar 20 and converts this signal, using suitable analog-to-digital logic, into a digital sound recording, i.e. a digitized sound track.

Optionally, the computing device may include a microphone and a speech-recognition subsystem for transforming voice input in the form of sound waves into an electrical signal. The electrical signal is then processed by a speech-recognition module (digital signal processor) to determine keywords or phrases from the voice input. The speech-recognition subsystem may be used to interact with the computing device and the web server.

Optionally, the computing device may include a speaker and/or an earphone jack for playing back sound tracks or re-amped sound tracks.

Still referring to FIG. 1, the computing device 12 transmits or uploads the digitized sound track to the re-amping management and file distribution server 100. The digitized sound track may be uploaded to the web site, transferred using FTP, attached to an e-mail, or transmitted in any other known way. This transmission/upload may be encrypted, e.g. using SSL. The server 100 has a processor and memory as well as a data communication port for data communication with users through the Internet. Data, e.g. application data, user account data, billing data, amplifier data, etc. may be stored at the server 100 or, optionally, may be stored at a database 110 connected to and accessible by the server 100. The server may be a single server, a server cluster or a cloud-computing environment.

The server 100, in one main embodiment, is a web server hosting a website having a specific web domain or URL that provides a web application interface for users. The web application may be coded using JavaScript, HTML, etc. The web application interface provided by server 100 thereby presents various options and enables user selection of various options. The server 100 thus enables the user to select an amplifier to be used to re-amp the sound track and also enables the user to select one or more sound effects (high rock, low rock, blues, country, etc.) to be used by the studio when the sound track is re-amped.

As shown in FIG. 1, the server 100 is connected by the Internet 50 to a plurality of studios, e.g. Studio A and Studio B, as a simple example. In each studio 120 there is a studio server 130, an amplifier 140, a microphone 150 and a mixer 160. To re-amp a sound track, the server 100 transmits the sound track as a sound file to the studio server 130. This communication may be encrypted, e.g. using a VPN between the server 100 and the studio server 130.

Studios may register via their respective studio servers 130 with the RMFD server 100. In registration and subsequent updates, each studio 120 indicates a list of amplifiers that are offered at the studio as well as a calendar or schedule of available timeslots when the recording studio is free. The server 100 may periodically poll studio servers to request and receive information indicating amplifier availability and room availability.

On receiving the selection command from the user selecting an amplifier, the server 100 then determines which one of the plurality of studios has the selected amplifier. The server may also determine if the amplifier is available at that studio in the processing timeframe (turnaround time) requested by the user. In one embodiment, each studio may submit pricing for re-amping using the various amps available. The pricing may be displayed on the web interface to enable the user to make a choice that is also based on price. The server may optionally select the studio that offers the best price within the requested turnaround time for the selected amp.

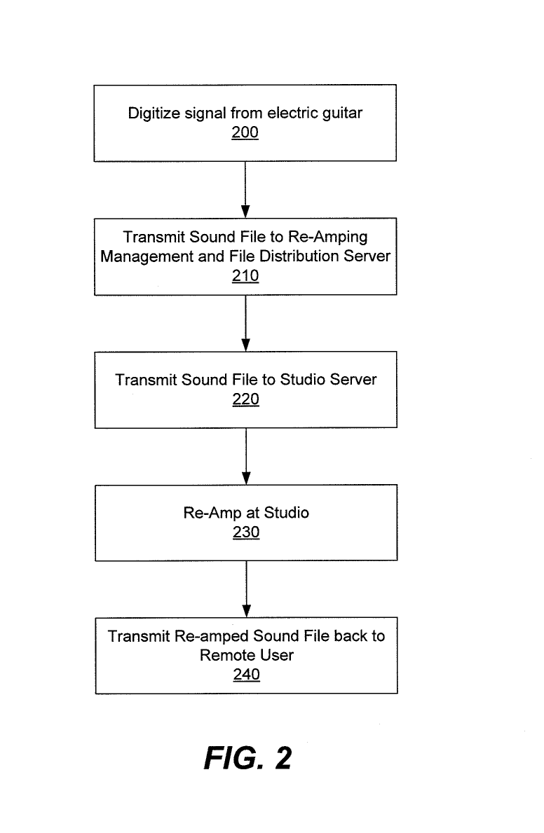

This novel system enables a novel method of re-amping a sound track. As depicted in FIG. 2, the method in general entails a step 200 of digitizing a signal from an electric guitar, a step 210 of transmitting the sound file to the re-amping management and file distribution (RMFD) server 100. Based on the criteria supplied by the user, the RMFD server 100 then decides where to send the sound file for re-amping. At step 220, the RMFD server 100 then sends the sound file to the identified studio server 130. At step 230, the studio 120 re-amps the sound track. Re-amping entails converting the sound track received by the studio server 130 using a digital-to-analog converter, playing the sound signal using the amplifier 140, and then recording the sound waves of the re-amped sound track using the microphone 150. A sound engineer may use a mixer 160 to mix the tones. At step 240, the studio server 130 then sends the re-amped sound track back to the user either directly to the user computing device 12 or indirectly via the RMFD server 100.

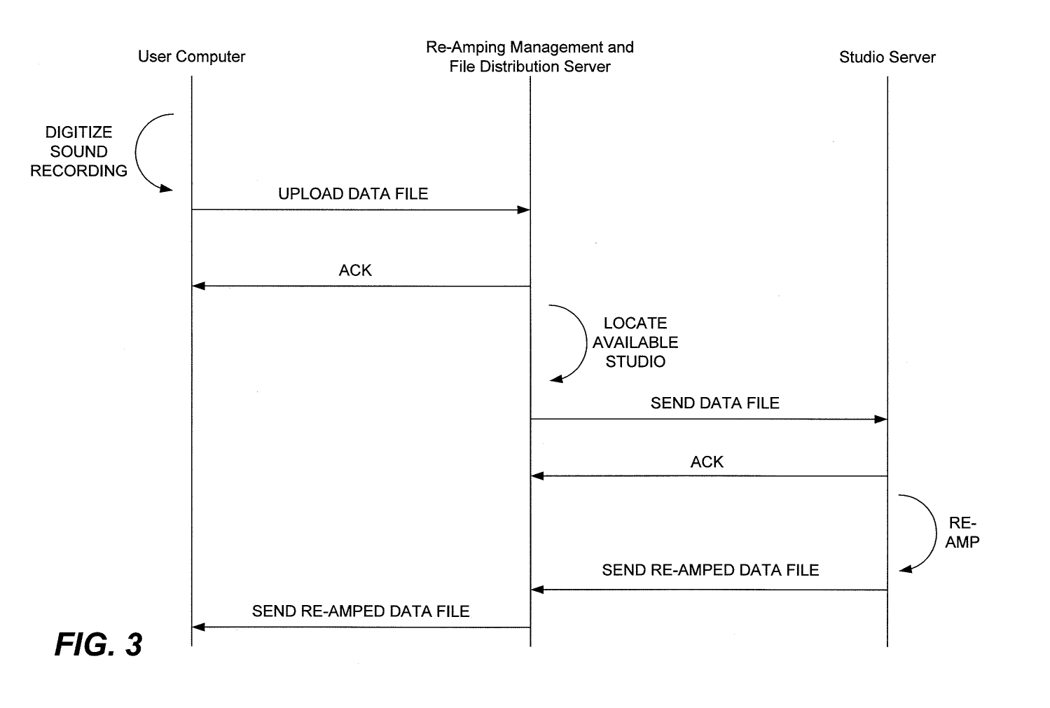

FIG. 3 depicts a message flow diagram showing how the user computing device 12 communicates with the re-amping management and file distribution (RMFD) server 100 which in turn communicates with one of a plurality of studio servers 130. As depicted, the user computer 12 captures a digitized sound recording. The user computer 12 employs a browser to access the RMFD web application hosted by the RMFD server 100. Once logged in, the computer 12 uploads a data file to the RMFD server 100. An acknowledgement message is sent back to the user computer. The RMFD server 100 locates an available studio based on the user's selection of an amplifier. The user sends a data file to the studio server 130 and receives an acknowledgement message back from the studio server. The re-amping is then performed by the studio. The studio server 130 sends the re-amped data file back to the RMFD server which then sends the data file back to the user computer 12.

In one embodiment, the server 100 receives the re-amped sound track and, in response to receiving the re-amped sound track from the studio server, transmits the re-amped sound track to the user computing device. In another embodiment, in response to receiving the re-amped sound track from the studio server, the server 100 transmits a notification message that the re-amped sound track is ready for download to the user computing device.

In one embodiment, the server 100 may include, or be connected to, an online payment processor employed to handle user payments. The payment processor may require payment when the re-amped sound track is made available for download (e.g. as a prerequisite to permitting the download). Alternatively, the payment processor may require payment prior to transmitting the sound file to the studio. The payment processor may also mediate payment between the server 100 and the studio. The server 100 may hold the paid funds in escrow or in trust until the studio has returned the re-amped sound track.

The RMFD server 100, as noted above, hosts a web application that provides a web interface to the user via a browser on the user's computer.

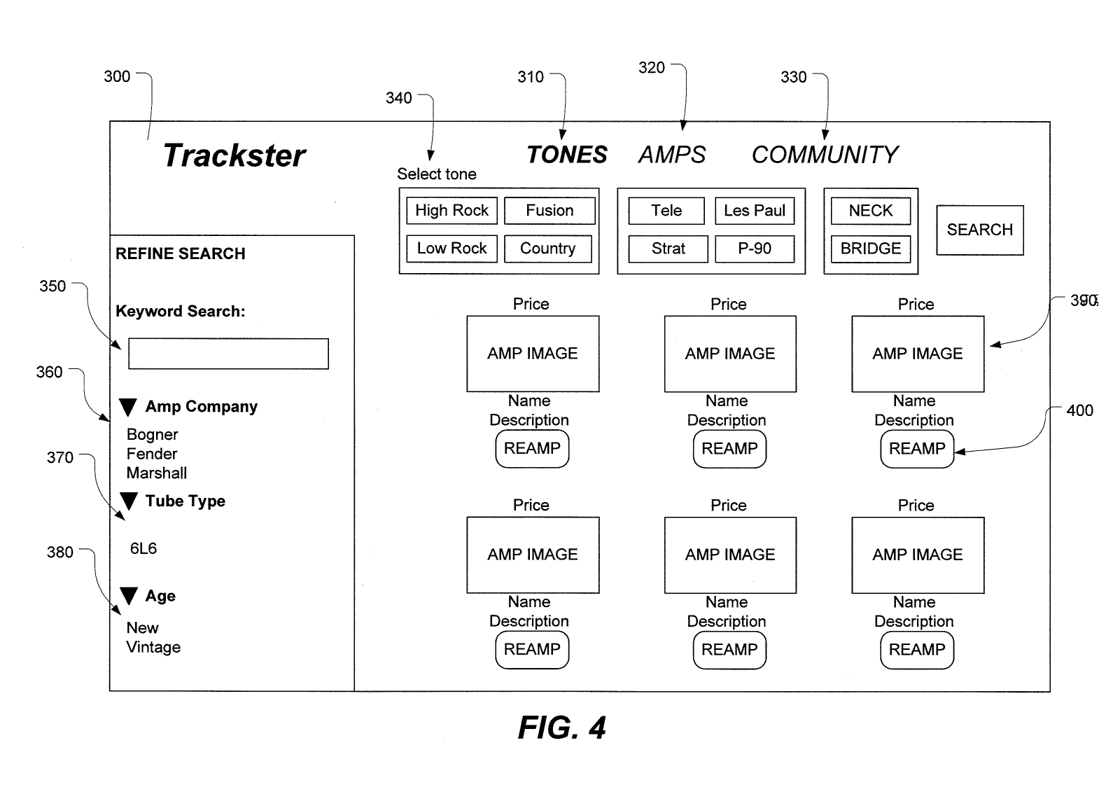

FIG. 4 depicts an example of a web-based user interface 300 for enabling a user to remotely re-amp a digitized sound track. As depicted in FIG. 4, the interface 300 may provide an onscreen space for a logo/name/trademark (e.g. “Trackster”). The interface provides various user interface elements or user-selectable interface elements that the user may touch, click or other select to cause the application to perform certain predetermined actions or tasks. The interface 300 includes user-selectable interface elements enabling the user to access specific pages or screens for tones 310, amps 320, and community 330. The interface 300 also includes user-selectable interface elements 340 to select a tone, e.g. high rock, low rock, fusion, country, Tele, Les Paul, Strat, P-90, neck, bridge. A search button may also be provided. A search refinement pane (“Refine Search”) may be displayed with a keyword search field 350, a list of amp companies 360 (e.g. Bogner, Fender, Marshall), a list of tube types 370 (e.g. 6L6), and an age category 380 (e.g. new, vintage). These are illustrated solely by way of example.

As depicted in FIG. 4, the interface displays a plurality of amplifier images 390 along with pricing, name, and description. A REAMP button 400 is provided in association with each amplifier to enable the user to provide a selection command to select that amplifier. In other words, the REAMP button 400 is used by the user to signify to the application that re-amping with that particular amplifier is desired. The application then determines which studio is available and sends the data file to the studio for re-amping. Optionally, the REAMP button triggers a confirmation request to the user, requiring the user to confirm the selection. Optionally, the REAMP button or the receipt of confirmation input triggers the displaying of a payment screen.

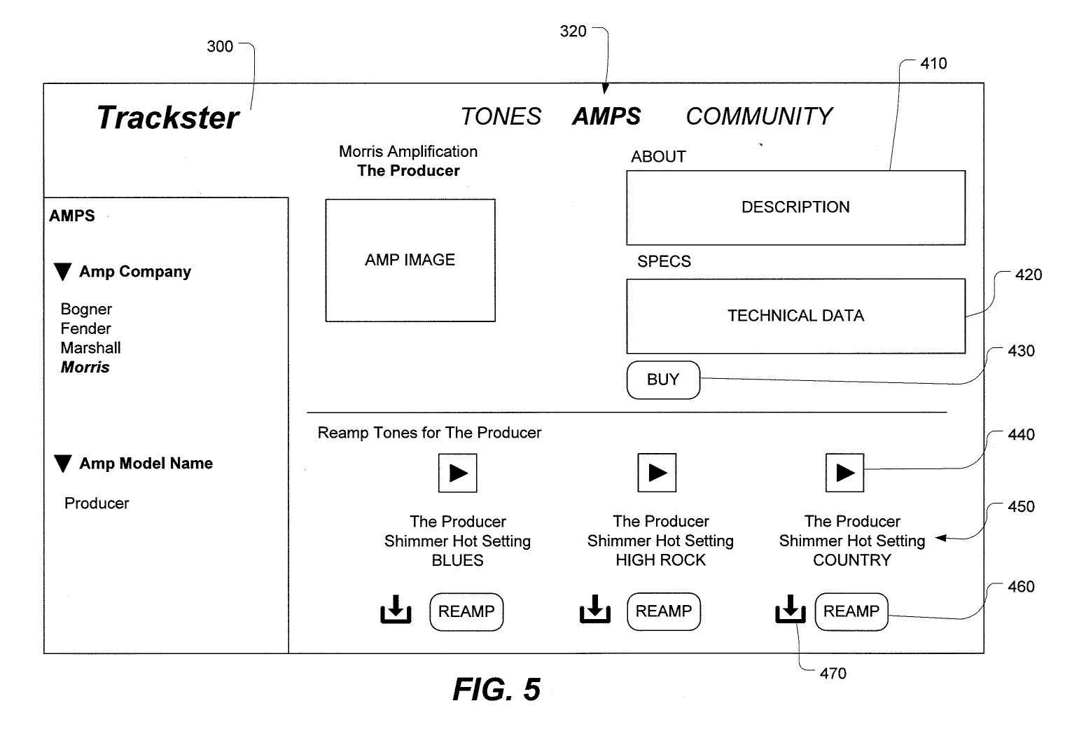

FIG. 5 depicts an example of another web-based user interface for enabling the user to remotely re-amp the digitized sound track. The screen of FIG. 5 is the AMPS page, which displays information about and an image of the amplifier that the user has selected. For example, the name of the amplifier manufacturer (e.g. “Morris Amplification”), the type of amplifier (e.g. “The Producer”), an image of the amplifier may be displayed as shown. A description of the sound of the amplifier may be displayed in a description 410 along with specs or other technical data 420. Optionally, a BUY button 430 may be provided to enable the user to buy the amplifier. Input provided to the BUY button may trigger display of an online shopping screen with payment and delivery options or it may simply link the user to a third party website (e.g. a manufacturer, distributor, retailer, etc.)

FIG. 5 further displays reamp tone options for the selected amp, e.g. “Reamp Tones for The Producer”. A plurality of different reamp tones are displayed, e.g. Blues, High Rock, Country, as a few examples. A play button 440 enables the user to play a sample of the reamp tone, i.e. an audio clip representative of the sound of the amplifier for the selected tone. A descriptor 450 also displays the name of the selected amp as shown by way of example. Also by way of example, a REAMP button 460 enables the user to select the desired tone. A save preferences button 470 enables the user to save the selection for future usage. The interface 300 thus displays user-selectable interface elements for various sound effect options (e.g. tones). On receiving a user selection, the server 100 transmits the sound effect selection to the studio server along with the sound track.

Any of the methods disclosed herein may be implemented in hardware, software, firmware or any combination thereof. Where implemented as software, the method steps, acts or operations may be programmed or coded as computer-readable instructions and recorded electronically, magnetically or optically on a fixed or non-transitory computer-readable medium, computer-readable memory, machine-readable memory or computer program product. In other words, the computer-readable memory or computer-readable medium comprises instructions in code which when loaded into a memory and executed on a processor of a computing device cause the computing device to perform one or more of the foregoing method(s).

A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A computer-implemented method performed by a re-amping management and file distribution (RMFD) server for remotely re-amping a digitized sound track, the method comprising:
receiving the digitized sound track recorded by a user on a user computing device having a data communication port for communicating the digitized sound track to the RMFD server;
presenting by the RMFD server a plurality of re-amping options to the user;
receiving by the RMFD server at least one re-amping selection command from the user computing device to select at least one option; and
transmitting the digitized sound track to a studio server for re-amping of the digitized sound track.

2. The method as claimed in claim 1 further comprising:
receiving the re-amped sound track; and
in response to receiving the re-amped sound track from the studio server, transmitting the re-amped sound track to the user computing device.

3. The method as claimed in claim 1 further comprising:
receiving the re-amped sound track; and
in response to receiving the re-amped sound track from the studio server, transmitting a notification message that the re-amped sound track is ready for download to the user computing device.

4. The method as claimed in claim 1 wherein the digitized sound track is recorded by the user computing device by digitally sampling an electric analog signal from an electric guitar connected to the user computing device.

5. The method as claimed in claim 1 wherein presenting the plurality of re-amping options comprises displaying images for a plurality of amplifiers in association with user-selectable interface elements that respond to a selection of one of the user-selectable interface elements by causing the RMFD server to send the track to an available studio server having a studio capable of re-amping the track with a selected amplifier.

6. The method as claimed in claim 5 further comprising presenting reamp tones for a selected amplifier including a user-selectable interface element that, in response to selection by the user, causes an audio clip representative of the sound of the selected amplifier to be played.

7. The method as claimed in claim 1 further comprising a search tool for searching a catalogue of available amplifiers.

8. A computer-readable medium comprising instructions in code which when loaded into a memory and executed by a processor of a web server cause the server to:
receive the digitized sound track recorded by a user on a user computing device having a data communication port for communicating the digitized sound track to the RMFD server;
present by the RMFD server a plurality of re-amping options to the user;
receive by the RMFD server at least one re-amping selection command from the user computing device to select at least one option; and
transmit the digitized sound track to a studio server for re-amping of the digitized sound track.

9. The computer-readable medium as claimed in claim 8 further comprising:
code for receiving the re-amped sound track; and
code for transmitting the re-amped sound track to the user computing device in response to receiving the re-amped sound track from the studio server.

10. The computer-readable medium as claimed in claim 8 further comprising:
code for receiving the re-amped sound track; and
code for transmitting a notification message that the re-amped sound track is ready for download to the user computing device in response to receiving the re-amped sound track from the studio server.

11. The computer-readable medium as claimed in claim 8 wherein the digitized sound track is recorded by the user computing device by digitally sampling an electric analog signal from an electric guitar connected to the user computing device.

12. The computer-readable medium as claimed in claim 8 wherein the code for presenting the plurality of re-amping options comprises code for displaying images for a plurality of amplifiers in association with user-selectable interface elements that respond to a selection of one of the user-selectable interface elements by causing the RMFD server to send the track to an available studio server having a studio capable of re-amping the track with a selected amplifier.

13. The computer-readable medium as claimed in claim 12 further comprising code for presenting reamp tones for a selected amplifier including a user-selectable interface element that, in response to selection by the user, causes an audio clip representative of the sound of the selected amplifier to be played.

14. The computer-readable medium as claimed in claim 8 further comprising code for displaying a search tool for searching a catalogue of available amplifiers.

15. A re-amping management and file distribution (RMFD) system comprising:
a memory for storing application data including amplifier data;
a data communication port for receiving a digitized sound track recorded by a user on a user computing device;
a processor operatively coupled to the memory for:
presenting a plurality of re-amping options to the user;
receiving at least one re-amping selection command from the user computing device to select at least one option; and
transmitting the digitized sound track to a studio server for re-amping of the digitized sound track.

16. The system as claimed in claim 15 wherein the processor is configured to determine an available studio from the selection command and cooperate with the data communication port to transmit the digitized sound track to a the studio server.

17. The system as claimed in claim 15 wherein the processor is configured to:
receive the re-amped sound track; and
in response to receiving the re-amped sound track from the studio server, cooperate with the data communication port to transmit to the user computing device either (i) the re-amped sound track or (ii) a notification message that the re-amped sound track is ready for download.

18. The system as claimed in claim 15 wherein the processor is configured to display images for a plurality of amplifiers in association with user-selectable interface elements that respond to a selection of one of the user-selectable interface elements by causing the track to be sent to an available studio server having a studio capable of re-amping the track with a selected amplifier.

19. The system as claimed in claim 15 wherein the processor is configured to serve data to a web-connected user computer device reamp tones for a selected amplifier including a user-selectable interface element that, in response to selection by the user, causes an audio clip representative of the sound of the selected amplifier to be played.

20. The system as claimed in claim 15 wherein the processor is configured to serve data to a web-connected user computer device that enables the computer to display user-selectable interface elements for various sound effect options, to receive user selection, and to transmit the sound effect selection to the studio server along with the sound track.
